(19) United States
(12) Patent Application Publication
(10) Pub. No.: US 2018/0370417 A1
(43) Pub. Date: Dec. 27, 2018

(54) Winder for a Band Shaped Element

(71) Applicant: Loyd Arve Nornes, Skudeneshavn (NO)

(72) Inventor: Loyd Arve Nornes, Skudeneshavn (NO)

(21) Appl. No.: 16/062,240

(22) PCT Filed: Dec. 7, 2016
(86) PCT No.: PCT/NO2016/050257

§ 371 Date: Jun. 14, 2018

(30) Foreign Application Priority Data
Dec. 22, 2015 (NO) 20151772

(51) Int. Cl. B60P 7/08; B65H 54/58

(52) U.S. Cl. CPC B60P 7/0846; B65H 2701/375; B65H 54/585

(57) ABSTRACT

A winder is for a band-shaped element. A stator includes an end wall, which forms a first side support for the band-shaped element, and a band guide arranged perpendicularly to the end wall. A rotor comprises an end cover which forms a second side support for the band-shaped element. A reel boss is arranged perpendicularly on the end cover and provided with an engagement portion for receiving an end portion of the band-shaped element. A cranking handle projects from the end cover at a distance from the center axis of the reel boss. The stator includes at least one spacer element which supportingly abuts by an end face against a rim portion of the end cover of the rotor, and the stator and the rotor comprise complementary radial-guide means arranged to center the rotor on the stator.

### FIELD

The invention relates to a winder for a band-shaped element.

### BACKGROUND

In the transport industry, load-securing straps are often used, which are used together with tensioning devices to secure objects to a base and prevent them from shifting during the movement of the means of transport. The load-securing straps are reused and when storing them temporarily, there is often a need to wind the load-securing straps. This is often done manually without the use of any aids.

From NO301635 a winder is known, in which a rotatable reel with a crank is supported in a support. The reel is provided with a locking member for a load-securing strap. The locking member is formed as a jaw arranged in a radial cut-out, the jaw being rotatable relative to the reel, thereby exerting a clamping force on an end portion of the load-securing strap placed in the cut-out. The support is provided with a supporting portion extending radially out from the bearing portion of the reel and forming a support only on one side of the strap reel. The winder has to be secured to a base before use.

U.S. Pat. No. 3,954,226A discloses a mechanism for coiling a cargo strap, in which a pipe projects from the center of a supporting plate. A crankshaft, which is provided with a slot in an end portion remote from the crank, may be inserted into the pipe so that the slot, which is arranged to receive an end portion of the cargo strap, projects from the supporting plate while the crank abuts against the free end of the pipe.

From http://strapwinder.co.uk an apparatus for winding a cargo strap is known, in which a crank with a split crankshaft is supported in the middle portion of an elongated plate element. A handle projects from a first end portion of the plate element, whereas a second end portion forms a guide for the cargo strap during winding.

EP0896200 A2 discloses a manual return concave blade tape measure. The tape measure includes a case having a right side shell, a tubular center member and a left side shell fastened together to define a closed interior for housing a measuring tape wound on a reel. The winding reel includes a core and a flange integrally attached to the core. The flange provides a guide during winding to help wind and maintain the tape blade in the cylindrical core. The core includes a hole in which the end of the tape blade is inserted and secured. The case remain closed after assembly and during operation of the measure. If opened, the spring energy stored in the wound tape would urge the blade to unwind, the friction ring compressed between the flange of the winding reel and the inner face of the right side shell makes reassembly of the reel complicated, the shells are fastened together to define the interior space, obviously by screws or the like through the holes indicated in the corners of the right shell and the left shell, and the hole in the core of the winding reel does not allow the wound tape to be released from the reel.

### SUMMARY

The invention has for its object to remedy or reduce at least one of the drawbacks of the prior art or at least provide a useful alternative to the prior art.

The object is achieved through the features that are specified in the description below and in the claims that follow.

In what follows, the term “strap” and derivatives of this word are used, said term covering load-securing straps and other band-like elements that need winding after use.

A winder for a strap is provided, in which a stator, preferably cylinder-shaped, with an axial extent corresponding to the width of the strap that is to be wound, has a closed first end portion and an open second end portion. A slot-shaped side opening extends over the entire longitudinal direction of the stator and has a preferably open end portion opposite the closed first end portion of the stator. The side opening has a width at least corresponding to the thickness of the strap. The side edges of the side opening are preferably rounded and form sliding surfaces for the strap. In one embodiment, a shaft projects into the stator from the closed, first end portion, preferably coinciding with the center axis of the stator.

Externally, the stator is preferably provided with a handle. Alternatively or additionally, the stator may be provided with means for attaching the stator to a base, especially a quick-fit coupling arranged to releasably receive a quick-fit mount, for example for the temporary attachment to a side edge of a platform body of a lorry. It is an advantage if the side opening of the stator faces downwards when the stator is attached to said base.

A rotor is arranged to be releasably connected to the stator, as an end cover arranged to close the open second end portion of the stator is provided with a reel boss which forms an attachment for an end portion of the strap and, in one embodiment, is provided with a center cut-out which may accommodate a substantial part of the shaft of the stator to form a radial guide for the rotor in the stator. On the opposite side of the end cover, a handle projects outwards from the end cover. In this embodiment of the radial guide of the rotor, the reel boss, end cover and handle of the end cover form a crank, which can be rotated around the shaft of the stator. The end cover is preferably circular.

The stator is preferably provided with an abutment for the rotor in order to maintain a minimum distance between the end wall of the stator and the end cover of the rotor, preferably as an abutment resting against a rim portion of the end cover of the rotor. The abutment may be formed as a cylinder-shaped sidewall, only interrupted by said slot forming the entrance for the strap. Alternatively, the sidewall may be interrupted, the openings between the different portions of the side wall giving the possibility of visual access into the stator during the winding of the strap. In one embodiment of the radial guide, a circumferential face on the rim portion of the end cover of the rotor may be encircled by a supporting face formed internally on an upper portion of the sidewall. It is an advantage if at least one of the rim portion of the rotor end cover and the end surface of the stator sidewall is stepped, so that both radial guiding and axial support are provided for the rotor against the stator.

In winding, one end portion of the strap is attached to the reel boss of the rotor. The rotor is connected to the stator as a portion of the strap is inserted into the side opening of the stator through the open end portion. The strap is then wound onto the rotor by the rotor being rotated relative to the stator. The end cover of the rotor and the end wall of the stator form supports for the wound strap. When the strap has been wound in, or possibly a fastening hook or the like at the other end portion of the strap has been pulled in to the side opening of the stator, the rotor and the wound strap are pulled out of the stator, and the wound strap is pulled off the rotor.

It may be an advantage to be able to lock the rotor axially to the stator.

It may be an advantage to be able to adjust the winder to different strap widths. In one embodiment, this may be achieved by providing one or more liner plates that may be placed in the stator, supported by the end wall, so that the clearance between the end wall of the stator and the end cover of the rotor is reduced. The liner plates may be formed in different thicknesses.

The invention is defined by the independent claim. The dependent claims define advantageous embodiments of the invention.

The invention relates, more specifically, to a winder for a band-shaped element, wherein
a stator includes an end wall, which is arranged to form a first side support for the band-shaped element, and a band guide arranged substantially perpendicularly to the end wall peripherally on the end wall and arranged for the band-shaped element to be passed through;
a rotor comprises an end cover which is arranged to form a second side support for the band-shaped element; a reel boss arranged perpendicularly on the end cover and provided with an engagement portion arranged to receive an end portion of the band-shaped element, and a crank handle projecting from the end cover in the direction opposite to that of the reel boss and at a distance from the center axis of the reel boss;
the stator comprises at least one spacer element which is arranged to abut supportingly by an end face against a rim portion of the end cover of the rotor; and
the stator and the rotor comprise complementary radial-guide means arranged to center the rotor on the stator, characterized in that:
the rotor is arranged to be pulled out of the stator for release of the wound band-shaped element.

The spacer element may be formed as a cylindrical sidewall projecting up from the end wall of the stator and being penetrated at least by the band guide. Alternatively, the sidewall may be formed as several separate sidewall sections spaced apart, projecting up from the end wall of the stator.

Said radial-guide means may be formed of a center cut-out in the reel boss of the rotor and a shaft that projects perpendicularly up from the end wall of the stator, the center cut-out being arranged to accommodate at least a portion of the shaft. Alternatively, said radial-guide means may be formed of a circumferential face of the end cover of the rotor and an internal supporting face on the sidewall.

The end cover of the rotor may be provided with a rim portion, in which a stepping circumferential face is arranged to be encircled by the spacer element, and an annular, stepped rim face is arranged to rest against the end face of the spacer element.

A handle may be arranged externally on the stator.

The band guide of the stator may have an open end portion.

An end portion of the shaft of the stator may be arranged to extend through the rotor and receive a locking means, the locking means resting supportingly, in an active position, against the rotor.

The stator may be arranged to receive one or more liner plates centered on the shaft.

### BRIEF DESCRIPTION OF THE DRAWINGS

In what follows, examples of preferred embodiments are described, which are illustrated in the accompanying drawings, in which

FIG. 1 shows an exploded perspective drawing of a winder viewed towards a closed end portion of a stator provided with a cylindrical sidewall;

FIG. 2 shows an exploded perspective drawing of the winder viewed towards an open end portion of the stator;

FIG. 3 shows a perspective drawing of a rotor with an end portion of a strap attached to a reel boss;

FIGS. 3a and 3b show radial sections through a portion of the stator and the rotor in alternative embodiments of a radial guiding of the rotor in the stator;

FIG. 4 shows a top view of the rotor;

FIG. 5 shows a top view of the stator with a sectioned sidewall;

FIG. 6 shows an assembled winder in perspective, in which a spring pin through a projecting portion of the center shaft of the stator fixes the rotor to the stator;

FIG. 7 shows an exploded perspective drawing of a stator with two liner plates for adjusting the winder to smaller strap widths; and

FIG. 8 shows a perspective drawing of a winder with a quick-release coupling for the connection to a mount on a base.

### DETAILED DESCRIPTION OF THE DRAWINGS

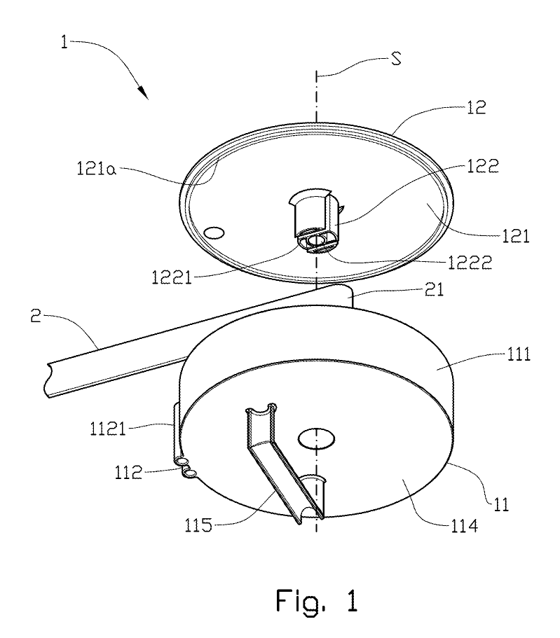

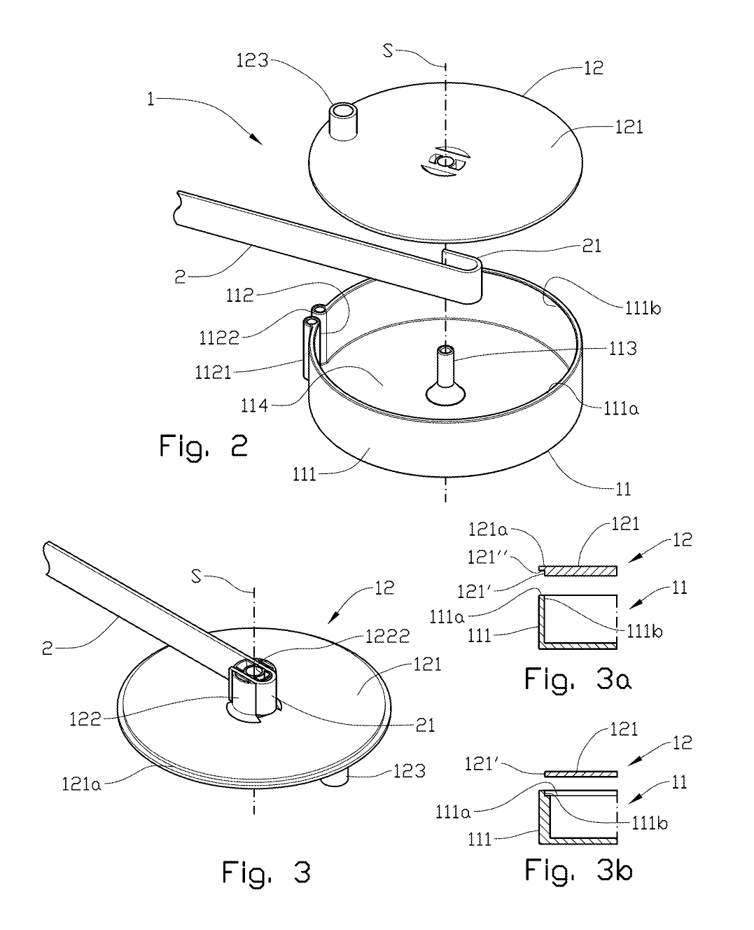

Reference is first made to FIGS. 1 and 2, in which the reference numeral 1 indicates a winder for a band-shaped element 2, for example a load-securing strap, the winder 1 comprising a stator 11 and a rotor 12.

The stator 11 is shown here with a cylindrical cross section having an end wall 114, extending from which there is a sidewall 111 which is interrupted by a slot-shaped band guide 112. The band guide 112 is provided with an open end portion 1122 and is defined against the side wall 111 by rounded guide edges 1121 (se FIG. 2 in particular) which also braces the side wall 111 in the end wall 114. The stator 11 has an open top. Coinciding axially with the center axis S of the stator 11, a shaft 113 projects up from the end wall 114 towards the open top of the stator 11 (see FIG. 2). Externally on the end wall 114, that is to say opposite the shaft 113, a handle 115 (see FIG. 1) is arranged. Alternatively, the handle 115 may be arranged externally on the sidewall 111.

The rotor 12 is formed of an end cover 121, shown as a circular one here. Perpendicularly on the end cover, and coinciding with the center axis S, a reel boss 122 is arranged, which is provided with an engagement portion 1221 arranged to receive and secure an end portion 21 of the band-shaped element 2 (see FIG. 3). The engagement portion 1221 is shown here as two parallel grooves arranged on either side of a center cut-out 1222 extending through the reel boss 122 and the end cover 121. The center cut-out 1222 is arranged to receive the shaft 113 of the stator 11. A cranking handle 123 projects from the end cover 121 near the circumference of the end cover 121 and in the opposite direction to that of the reel boss 122 (see FIG. 2).

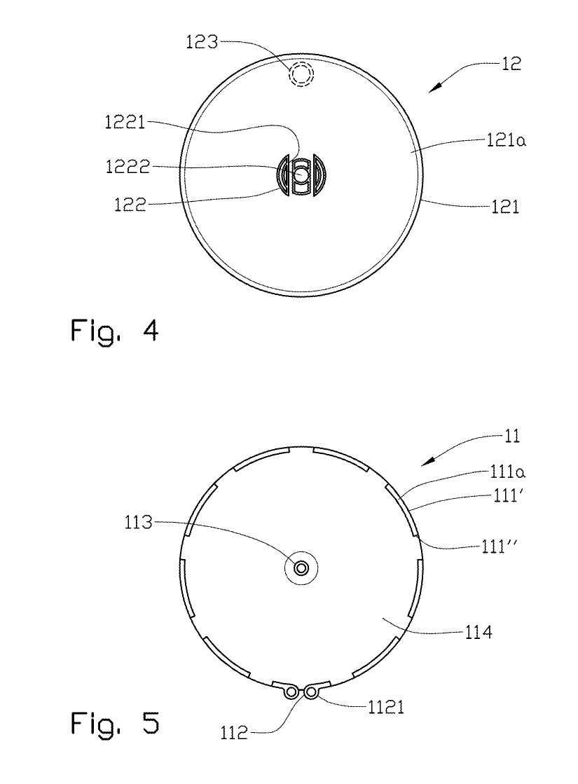

In this embodiment, the shaft 113 and the complementary center cut-out 1222 form a radial guide for the rotor 12 relative to the stator 11, and the reel boss 122, the end cover 121 and the cranking handle 123 form a crank which can be rotated around the shaft 113 of the stator 11. See also FIG. 4.

The side wall 111 forms a spacer element for the rotor 12 relative to the end wall 114 of the stator 11, as an end face 111a (see FIG. 2) of the side wall 111 is arranged to rest against a rim portion 121a of the end cover 121 of the rotor 12. FIG. 3 and FIG. 3a show a stepped rim portion 121a, in which a stepping circumferential face 121′ defines an annular rim face 121″ (see FIG. 3a in particular). When the rotor 12 is connected to the stator 11, the annular rim face 121″ is resting against the end face 111a of the end wall 114, the upper portion of the sidewall 111 forming a supporting face 111b encircling said circumferential face 121′ and forming a radial guide for the rotor 12.

FIG. 3b shows an alternative form of a radial guide of the rotor 12 relative to the stator 11, said end face 111a being stepped in such a way that the end cover 121 of the rotor may be recessed into the stator 11.

The embodiments of the radial guide that are shown in FIGS. 3, 3a and 3b may replace the radial guide formed of the shaft 113 and the complementary center cut-out 1222 shown in FIGS. 1 and 2 and described above.

In FIG. 5, an alternative embodiment of the stator 11 is shown, in which, from the circumference of the end wall 114, several sidewall sections 111′ project, separated by side openings 111″. In the same way as described above concerning the side wall 111, the side-wall sections 111′ form spacer elements for the rotor 12, as the end faces 111a of the sidewall sections 111′, too, form abutments for the end cover 121 of the rotor 12.

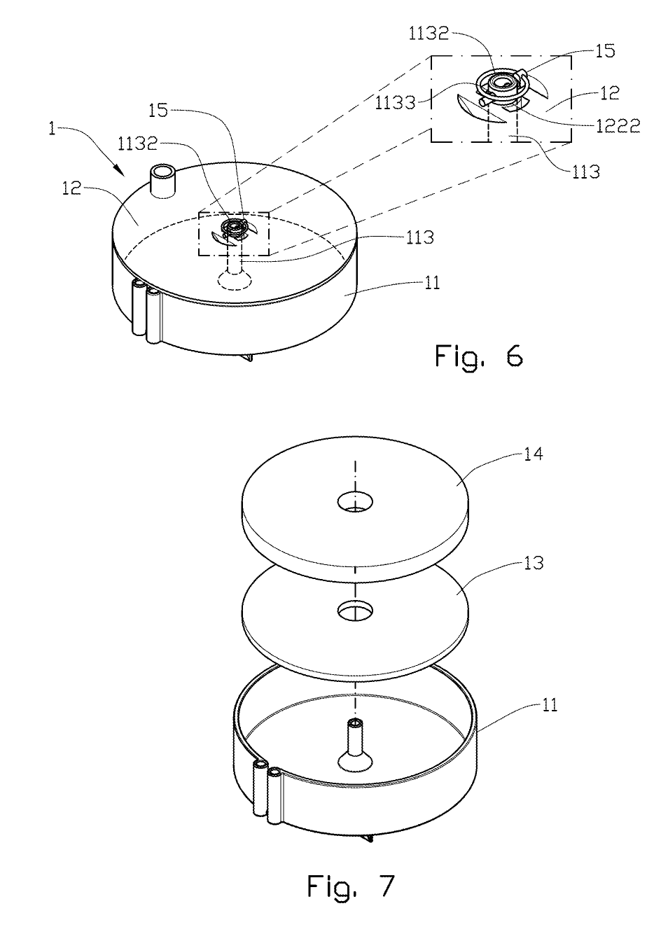

Reference is now made to FIG. 6, in which an alternative embodiment of the winder 1 is shown. In this embodiment, the shaft 113 of the stator 11 is provided with an end portion 1132, which, in the assembled state of the winder 1, projects out from the center cut-out 1222 of the rotor 12. A locking means 15, shown here as a linchpin, has been passed through a radial bore 1133 in said end portion 1132 and is resting supportingly against the end cover 121 of the rotor 12. The locking means 15 is particularly practical when the winder 1 is being stored.

Reference is now made to FIG. 7, in which first and second liner plates 13, 14 of different thicknesses are shown about to be inserted into the stator 11, the effective axial length of the stator 11 thereby being reduced to adapt the winder 1 for a band-shaped element with a smaller width.

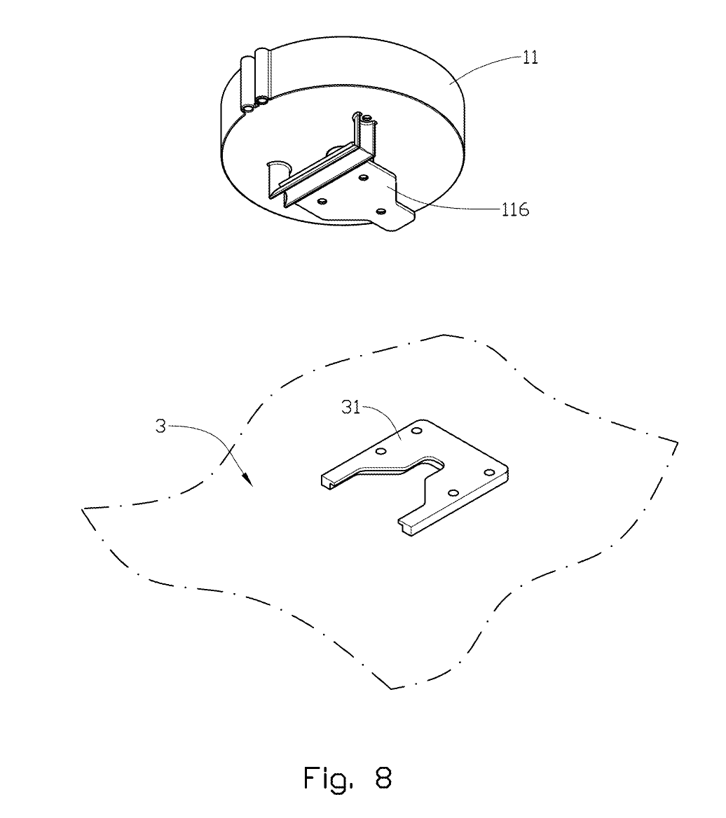

In FIG. 8, the stator 11 is provided with an attachment 116, shown here as a quick-release coupling, for the connection to a base 3, typically via a quick-release mount 31 which is permanently fixed to the base 3.

When a band-shaped element 2, for example a load-securing strap, is to be rolled up to occupy as little space as possible during storing, for example, the rotor 12 is pulled out of the stator 11. The end portion 21 of the band-shaped element 2 is inserted into the engagement portion 1221 of the reel boss 122 of the rotor 12. The band-shaped element 2 is extended in the radial direction out from the reel boss 122, and the rotor 12 and the band-shaped element 2 are inserted into the stator 11, as the band-shaped element 2 is inserted sideways into the slot-shaped band guide 112 of the stator 11 through the open end portion 1122 of the band guide 112. The rotor 12 is rotated around the shaft 113 of the stator 11, so that the band-shaped element 2 is wound around the reel boss 122. When the band-shaped element 2 has been wound up, the rotor 12 is pulled out of the stator 11 together with the coil.

It should be noted that all the above-mentioned embodiments illustrate the invention, but do not limit it, and persons skilled in the art may construct many alternative embodiments without departing from the scope of the attached claims. In the claims, reference numbers in parentheses are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. A winder for a band-shaped element, the winder comprising:
a stator comprising an end wall, which is arranged to form a first side support for the band-shaped element, and a band guide arranged substantially perpendicularly to the end wall peripherally on the end wall and arranged for the band-shaped element to be passed through;
a rotor comprising an end cover which is arranged to form a second side support for the band-shaped element;
a reel boss arranged perpendicularly on the end cover and provided with an engagement portion arranged to receive an end portion of the band-shaped element, and a cranking handle projecting from the end cover in the opposite direction to that of the reel boss and at a distance from the center axis of the reel boss;
the stator comprising at least one spacer element which is arranged to supportingly abut by an end face against nearly an entire circumference of a rim portion of the end cover of the rotor; and
the stator and the rotor comprising complementary radial-guide means arranged to center the rotor on the stator,
wherein the rotor is arranged to be pulled out of the stator for release of the wound band-shaped element.

2. The winder according to claim 1, wherein the spacer element is formed as a cylindrical side wall projecting up from the end wall of the stator and being penetrated at leased by the band guide.

3. The winder according to claim 2, wherein the side wall is formed as several separate side-wall sections which, spaced apart, project up from the end wall of the stator.

4. The winder according to claim 1, wherein said radial-guide means are formed of a center cut-out in the reel boss of the rotor and a shaft which projects perpendicularly up from the end wall of the stator, the center cut-out being arranged to accommodate at least a portion of the shaft.

5. The winder according to claim 1, wherein said radial-guide means are formed of a circumferential face on the end cover of the rotor and an internal supporting face on a side wall.

6. The winder according to claim 1, wherein the end cover of the rotor is provided with a rim portion, wherein a stepping circumferential face is arranged to be encircled by the spacer element, and an annular, stepped rim face is arranged to rest against the end face of the spacer element.

7. The winder according to claim 1, wherein a handle is arranged externally on the stator.

8. The winder according to claim 1, wherein the band guide of the stator has an open-end portion.

9. The winder according to claim 4, wherein an end portion of the shaft of the stator is arranged to extend through the rotor and receive a locking means, the locking means resting supportingly, in an active position, against the rotor.

10. The winder according to claim 1, wherein the stator is arranged to receive one or more liner plates centered on a shaft which projects perpendicularly up from the end wall of the stator.
